(19) United States
(12) Patent Application Publication
(10) Pub. No.: US 2011/0250096 A1
(43) Pub. Date: Oct. 13, 2011

(54) HONEYCOMB STRUCTURE

(75) Inventors: Takahiko IDO, Ibi-Gun (JP); Yoshihiro Koga, Ibi-Gun (JP); Takumi Asanuma, Ibi-Gun (JP); Takashi Ito, Ibi-Gun (JP)

(73) Assignee: IBIDEN CO., LTD., Ogaki-Shi (JP)

(21) Appl. No.: 13/032,549

(22) Filed: Feb. 22, 2011

(30) Foreign Application Priority Data
Apr. 9, 2010 (JP) PCT/JP2010/056482

(51) Int. Cl. B01D 53/86; B01D 53/34

(52) U.S. Cl. 422/177; 422/168

(57) ABSTRACT

A honeycomb structure includes at least one honeycomb unit. The at least one honeycomb unit includes a pair of electrodes and cell walls. The cell walls extend along a longitudinal direction of the at least one honeycomb unit to define a plurality of through holes. The cell walls have pores filled with a substance under a formation region of the pair of electrodes. The substance has an electrical resistivity lower than an electrical resistivity of a material to form the at least one honeycomb unit.

### CROSS-REFERENCE TO RELATED APPLICATIONS

The present application claims priority under 35 U.S.C. §119 to International Application No. PCT/JP2010/056482, filed on Apr. 9, 2010, the entire contents of which are incorporated herein by reference.

### BACKGROUND OF THE INVENTION

1. Field of the Invention

The present invention relates to a honeycomb structure.

2. Description of the Related Art

A large number of techniques have been developed in relation to conversion of automobile exhaust gas. With an increase in traffic, however, countermeasures taken against exhaust gas have hardly been satisfactory. Not only in Japan but also globally, is automobile emission control going to be further tightened.

In order to meet such control, a catalyst support capable of treating predetermined components contained in exhaust gas is used in exhaust gas systems. Further, a honeycomb structure is known as a member for such a catalyst support.

This honeycomb structure has, for example, multiple cells (through holes) extending from one to another of the end faces of the honeycomb structure along its longitudinal directions, and these cells are separated from each other by cell walls supporting a catalyst. Accordingly, in the case of causing exhaust gas to flow through this honeycomb structure, substances contained in the exhaust gas, such as HC (a hydrocarbon compound), CO (carbon monoxide), and NOx (nitrogen oxides), are converted (oxidized or reduced) by the catalyst supported by the cell walls, so that these components in the exhaust gas may be treated.

In general, the cell walls (base material) of such a honeycomb structure are formed of cordierite. Further, a catalyst support layer of γ-alumina is formed on the cell walls, and a catalyst of a noble metal such as platinum and/or rhodium is supported on this catalyst support layer.

Further, a technique has been proposed that, in order to improve conversion performance at exhaust gas temperatures lower than a temperature at which a catalyst becomes active, uses a honeycomb structure of a relatively low resistance and supplies the honeycomb structure with electric current via electrodes for voltage application provided on the honeycomb structure, thereby causing the honeycomb structure to perform self-heating (Japanese Laid-Open Utility Model Application No. 49-124412).

The entire contents of Japanese Laid-Open Utility Model Application No. 49-124412 are incorporated herein by reference.

### SUMMARY OF THE INVENTION

According to one aspect of the present invention, a honeycomb structure includes at least one honeycomb unit. The at least one honeycomb unit includes a pair of electrodes and cell walls. The cell walls extend along a longitudinal direction of the at least one honeycomb unit to define a plurality of through holes. The cell walls have pores filled with a substance under a formation region of the pair of electrodes. The substance has an electrical resistivity lower than an electrical resistivity of a material to form the at least one honeycomb unit.

### BRIEF DESCRIPTION OF THE DRAWINGS

Other objects, features and advantages of the present invention will become more apparent from the following detailed description when read in conjunction with the accompanying drawings, in which:

FIG. 1 is a perspective view typically illustrating a honeycomb structure according to an embodiment of the present invention;

FIG. 2 is a plan view of an end face of the honeycomb structure illustrated in FIG. 1;

FIG. 3 is a perspective view typically illustrating another honeycomb structure according to the embodiment of the present invention;

FIG. 4 is a perspective view typically illustrating a honeycomb unit of the honeycomb structure of FIG. 3; and

FIGS. 5A and 5B are plan views of end faces of the honeycomb unit of FIG. 4.

### DESCRIPTION OF THE EMBODIMENTS

The embodiments will now be described with reference to the accompanying drawings, wherein like reference numerals designate corresponding or identical elements throughout the various drawings.

According to the conventional honeycomb structure described in Japanese Laid-Open Utility Model Application No. 49-124412, the honeycomb structure may be subjected to resistance heating by supplying the honeycomb structure with electric current via electrodes provided one at each end of the honeycomb structure. However, according to the conventional honeycomb structure described in Japanese Laid-Open Utility Model Application No. 49-124412, an extremely large potential is applied locally to the electrode portions from an external power supply. Therefore, abnormal heat generation may be caused to the electrode portions to degrade or damage the electrodes. Thus, it is believed that the conventional honeycomb structure described in Japanese Laid-Open Utility Model Application No. 49-124412 has a problem in stability over a long period of time.

According to one embodiment of the present invention, it is possible to obtain a honeycomb structure less likely to suffer degradation of electrodes and usable with long-term stability.

A description is given, with reference to the drawings, of an embodiment of the present invention.

### [First Configuration]

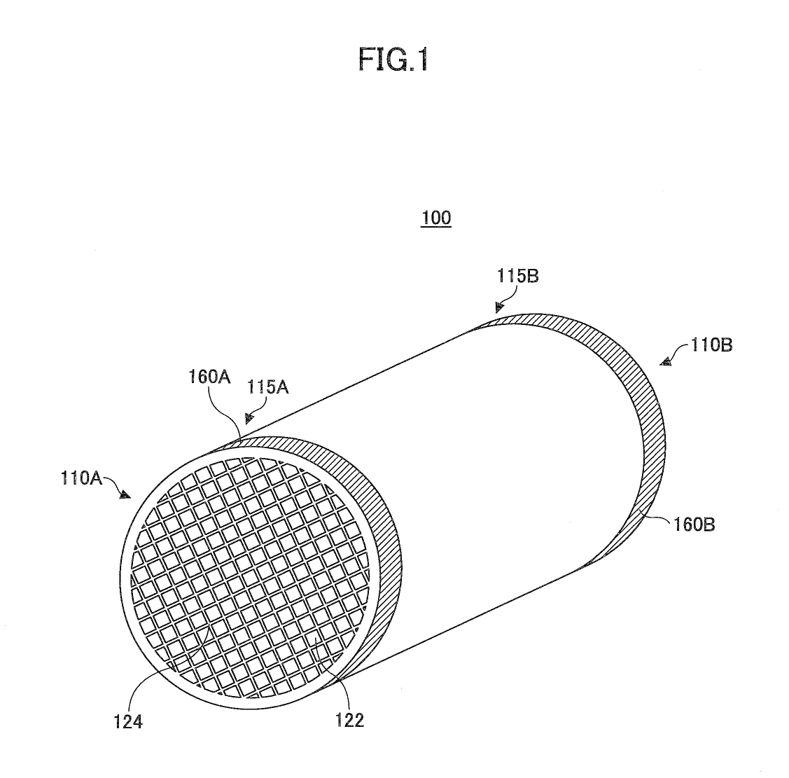

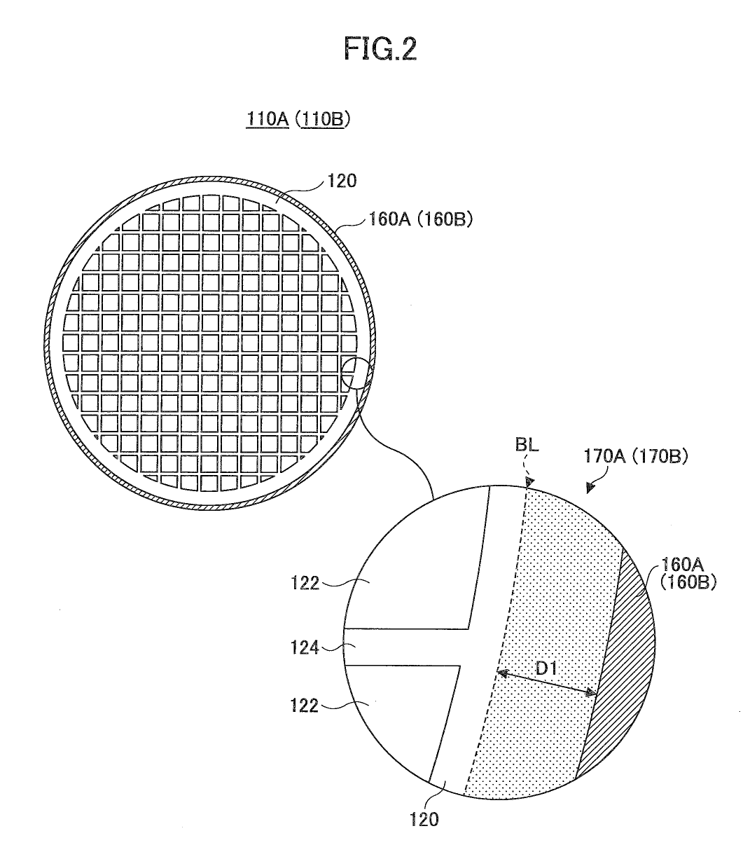

FIG. 1 typically illustrates a honeycomb structure 100 according to the embodiment of the present invention. Further, FIG. 2 is a plan view of an end face of the honeycomb structure 100 illustrated in FIG. 1.

As illustrated in FIG. 1, the honeycomb structure 100 according to the embodiment of the present invention is formed of a single honeycomb unit having two open end faces 110A and 110B. The honeycomb unit is a porous body. Further, the honeycomb structure 100 includes multiple cells (through holes) 122 and cell walls 124 defining the cells 122. The cells 122 extend from the end face 110A to the end face 110B along the longitudinal directions of the honeycomb structure 100 to be open at the end faces 110A and 110B.

An electrode 160A and an electrode 160B are provided around portions extending from the end faces 110A and 110B, respectively, of the honeycomb structure 100. (Hereinafter, these portions are referred to as “end portion 115A” and “end portion 115B”, respectively, of the honeycomb structure 100. See also FIG. 2.)

The honeycomb structure 100 is formed of, for example, a material having silicon carbide (SiC) as a principal component, to which a small amount of a resistance adjusting component such as aluminum nitride (AlN) is further added in order to lower resistance. A catalyst is provided on the cell walls 124 of the honeycomb structure 100.

The honeycomb unit forming the honeycomb structure 100 may also be referred to as “electrically conductive honeycomb unit.”

The electrodes 160A and 160B are formed of an electrically conductive material such as metal. The method of forming the electrodes 160A and 160B is not limited in particular. The electrodes 160A and 160B may be provided on the end portions 115A and 115B of the honeycomb structure by, for example, metal spraying, sputtering, vapor deposition, or the like.

The honeycomb structure 100 thus configured may be subjected to resistance heating by externally applying voltage between the electrodes 160A and 160B.

Here, as illustrated in detail in FIG. 2, the honeycomb structure 100 according to the embodiment of the present invention further includes low resistance portions 170A and 170B at least directly under the electrodes 160A and 160B, respectively. The low resistance portions 170A and 170B are provided in an exterior wall 120 defining the outer peripheral surface of the honeycomb structure 100 so as to be in contact with the electrodes 160A and 160B in the end portions 115A and 115B, respectively, of the honeycomb structure 100.

The “low resistance portion” may refer to part of the honeycomb unit which part is filled with a substance lower in electrical resistivity than a material forming the honeycomb unit.

The low resistance portions 170A and 170B are lower in resistivity than other regions of the honeycomb structure 100 (except the electrodes 160A and 160B). The low resistance portions 170A and 170B are formed by filling some of the pores present at the surface of the exterior wall 120 of the end portions 115A and 115B of the honeycomb structure 100 with an electrically conductive substance including a metal and/or a silicide, etc. The metal may be silicon (Si), nickel (Ni), etc. The silicide may be, for example, nickel silicide (NiₓSi_{y}), chromium silicide (CrₓSi_{y}), iron silicide (FeₓSi_{y}), etc.

These low resistance portions 170A and 170B serve as regions to ease local concentration of electric energy on the electrode portions at the time of supplying the honeycomb structure 100 with electric current via the electrodes 160A and 160B. That is, the presence of the low resistance portions 170A and 170B directly under the electrodes 160A and 160B is likely to prevent local generation of high heat in the electrodes 160A and 160B. Further, this is likely to deter degradation or breakage of the electrodes 160A and 160B, thus allowing the honeycomb structure 100 to be used with long-term stability.

The range of filling of the low resistance portions 170A and 170B is not limited in particular as long as the low resistance portions 170A and 170B are in contact with the electrodes 160A and 160B. For example, in the case of FIG. 2, the filling of the low resistance portions 170A and 170B is performed in the region between the outer peripheral surface of the exterior wall 120 of the honeycomb structure 100 (that is, the lowermost surfaces of the electrodes 160A and 160B) and a boundary line BL, and the depth D1 of the filling is preferably approximately 30 μm to approximately 100 μm. However, the value of the depth D1 from the outer peripheral surface of the exterior wall 120 to the boundary line BL may be substantially equal to or more than the thickness of the exterior wall 120 (for example, approximately 300 μm to approximately 400 μm).

Further, in the case of having difficulty in locally performing filling for the low resistance portions 170A and 170B, the filling may be performed substantially throughout the end portions 115A and 115B (that is, including the cell walls 124 of the end portions 115A and 115B) to form the low resistance portions 170A and 170B.

The amount of the electrically conductive substance with which the low resistance portions 170A and 170B are filled (the ratio of the weight of the electrically conductive substance to the total weight of the end portion 115A or 115B) is not limited in particular, but is preferably approximately 1 wt % to approximately 80 wt %, and more preferably, approximately 20 wt % to approximately 55 wt %.

Further, since the low resistance portions 170A and 170B are filled, the porosity of the end portion 115A or 115B (where the low resistance portion 170A or 170B is filled) is preferably 0% to approximately 20%.

As described above, according to the present invention, pores of the outer peripheral wall (exterior wall) of a honeycomb unit are filled with a substance of low electrical resistivity (a low resistance substance) where the outer peripheral wall defines an outer periphery of the honeycomb unit provided with electrodes. The pores of the outer peripheral wall are connected to each other to form a three-dimensional opening structure. Since this opening is filled with the substance of low electrical resistivity (low resistance substance), the three-dimensional structure of the low resistance substance is present in the outer peripheral wall. Therefore, compared with the case where such a low resistance substance is among particles of the outer peripheral wall, the resistance of outer peripheral wall portions where the electrodes are formed is likely to be lowered, so that the amount of heat generation of the outer peripheral wall portions where the electrodes are formed is likely to be reduced in the case of supplying electric current. Therefore, it is likely to be possible to deter degradation of the electrode material.

Further, according to the present invention, in the case where “the honeycomb unit includes an outer peripheral wall defining an outer periphery and interior walls separating the through holes of the honeycomb unit; the electrodes are formed on the outer peripheral surface of the outer peripheral wall; the interior walls are electrically connected to the outer peripheral wall having the electrodes formed thereon, and the pores are filled with the substance lower in electrical resistivity than the material forming the honeycomb unit in the interior walls,” the outer peripheral wall and the interior walls are substantially equal in potential in the end portions of the honeycomb unit, so that it is likely to be possible to equalize the density of current flowing through the peripheral wall with the density of current flowing through the interior walls. Further, this is likely to allow the amount of heat generation to be uniform throughout the honeycomb unit.

### [Second Configuration]

The honeycomb structure 100 illustrated in FIG. 1 is a honeycomb structure formed of a single honeycomb unit, that is, has a so-called “monolithic structure.” The embodiment of the present invention, however, may also be applied to a honeycomb structure having a so-called “aggregated structure,” which is formed of multiple honeycomb units.

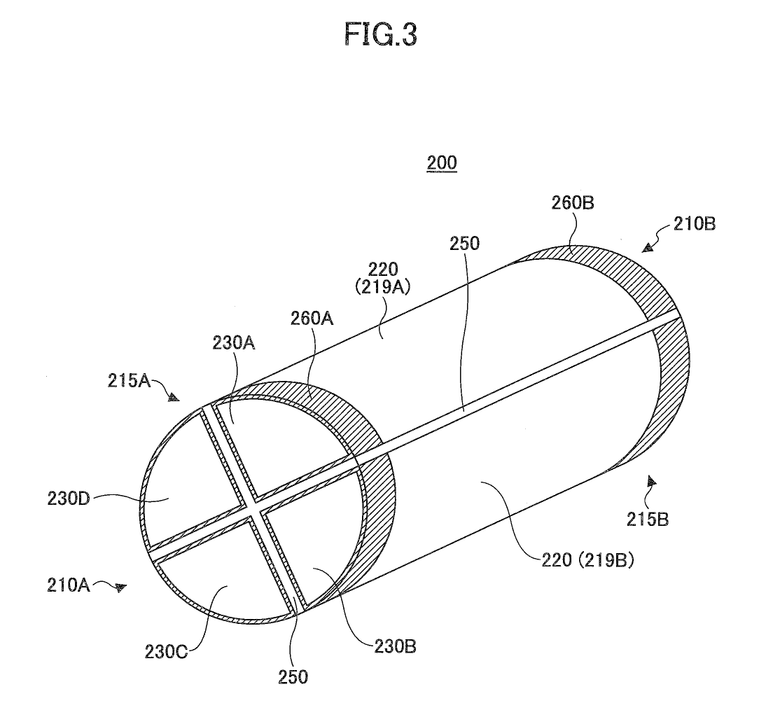

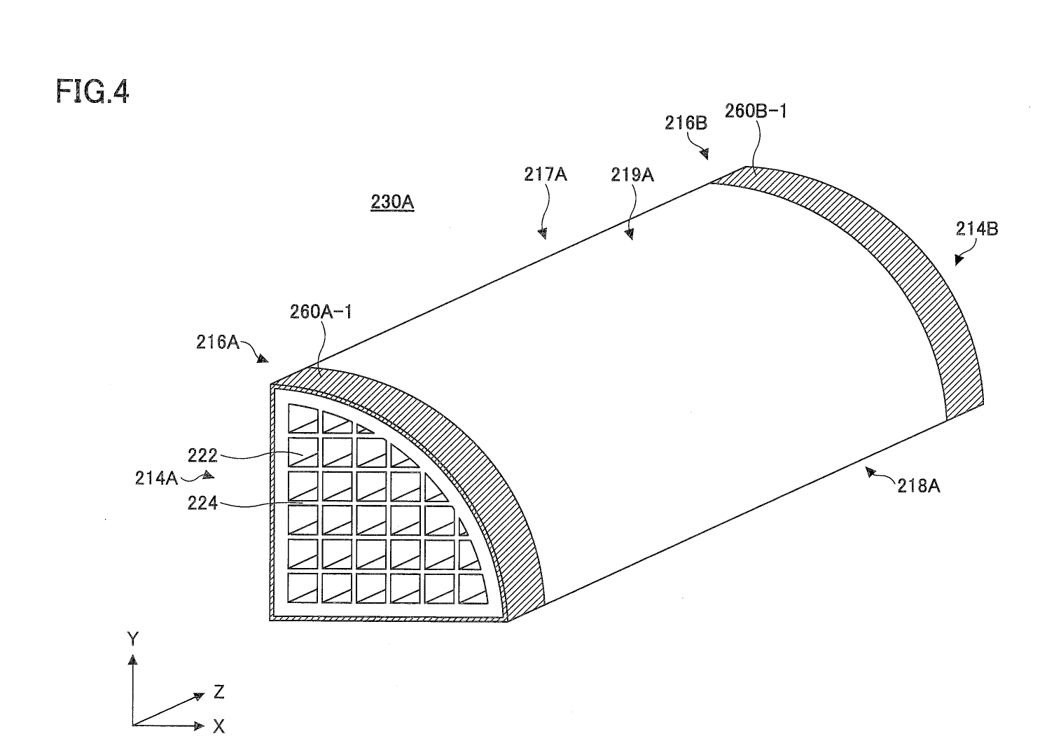

FIG. 3 illustrates a honeycomb structure 200 of “aggregated structure” according to the embodiment of the present invention. Further, FIG. 4 illustrates a typical honeycomb unit of the honeycomb structure 200 illustrated in FIG. 3.

As illustrated in FIG. 3, the honeycomb structure 200 according to the embodiment of the present invention has two open end faces 210A and 210B and a side surface 220.

The honeycomb structure 200 is formed by joining multiple honeycomb units by interposing an adhesive layer 250. For example, in the case illustrated in FIG. 3, the honeycomb structure 200 includes four honeycomb units 230A through 230D. The honeycomb units 230A through 230D are porous bodies.

As illustrated in FIG. 4, the honeycomb unit 230A has a pillar structure having end faces 214A and 214B having a substantially sectorial shape of a substantially quarter circle and three sides 217A, 218A, and 219A. Of these, the side 217A and the side 218A have a substantially flat surface, and the side 219A is a side having a curved surface (hereinafter referred to as “curved side”). In the case of FIG. 3, the honeycomb units 230B through 230D have substantially the same shape as the honeycomb unit 230A. For example, as illustrated in FIG. 3, the honeycomb unit 230B has a curved side 219B corresponding to the curved side 219A of the honeycomb unit 230A.

The honeycomb unit 230A includes multiple cells 222 and cell walls 224 defining the cells 222. The cells 222 extend from the end face 214A to the end face 214B along the longitudinal directions of the honeycomb unit 230A to be open at the end faces 214A and 214B. The honeycomb unit 230A is formed of, for example, a material including silicon carbide (SiC) as a principal component, to which a small amount of a resistance adjusting component such as aluminum nitride (AlN) is added in order to lower resistance. A catalyst is provided on the cell walls 224 of the honeycomb unit 230A.

An electrode 260A-1 and an electrode 260B-1 are provided around portions extending from the end faces 214A and 214B (hereinafter referred to as “end portion 216A” and “end portion 216B”), respectively, of the honeycomb unit 230A. In the case of FIG. 4, the electrodes 260A-1 and 260B-1 are, but do not necessarily have to be, provided entirely around the portions extending from the end faces 214A and 214B (that is, around the entire end portions 216A and 216B), respectively, of the honeycomb unit 230A. The electrodes 260A-1 and 260B-1 are provided on the honeycomb unit 230A at least on the side of its curved side 219A.

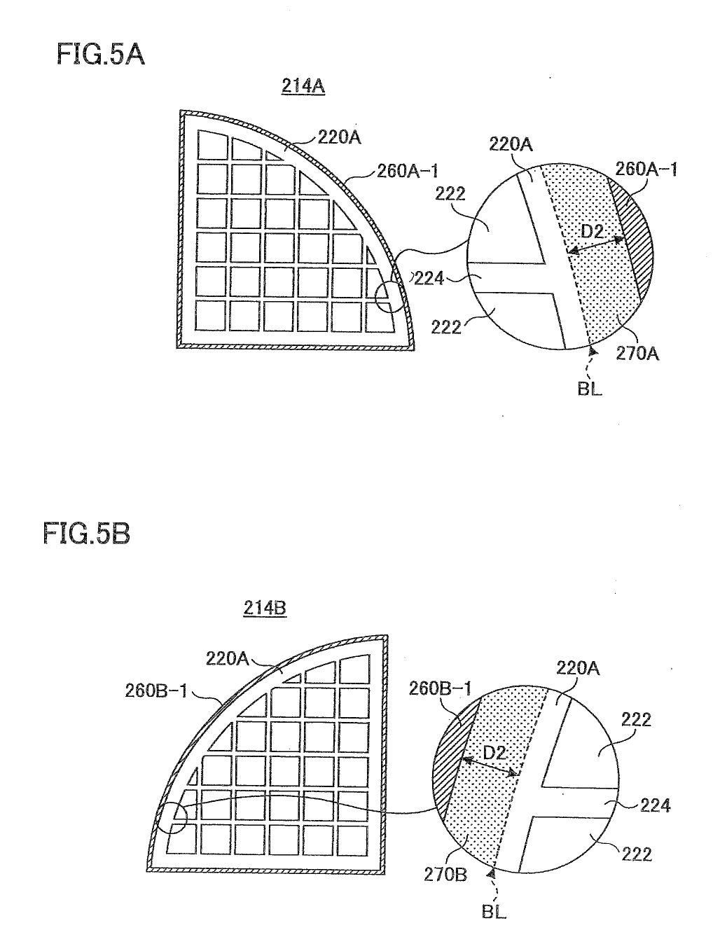

Further, the honeycomb unit 230A has low resistance portions 270A and 270B at least directly under the electrodes 260A-1 and 260B-1, respectively, as illustrated in FIG. 5. For example, when the electrodes 260A-1 and 260B-1 are provided entirely around the end portions 216A and 216B, respectively, of the honeycomb unit 230A as in FIG. 4, the low resistance portions 270A and 270B are also provided peripherally in the entire end portions 216A and 216B, respectively. On the other hand, if the electrodes 260A-1 and 260B-1 are provided only on the side of the curved side 219A of the honeycomb unit 230A, the low resistance portions 270A and 270B are provided only on the side of the curved side 219A of the honeycomb unit 230A.

The low resistance portions 270A and 270B are lower in resistivity than other regions of the honeycomb unit 230A. Further, the low resistance portions 270A and 270B are formed by filling some of the pores present at the surface of an exterior wall 220A of the end portions 216A and 216B of the honeycomb unit 230A with an electrically conductive substance including a metal and/or a silicide, etc.

Further, in FIG. 5, the filling of the low resistance portions 270A and 270B is performed in the region between the surface of the exterior wall 220A of the honeycomb unit 230 (that is, the lowermost surfaces of the electrodes 260A-1 and 260B-1) and a boundary line BL, and the depth D2 of the filling is preferably approximately 30 μm to approximately 100 μm. However, the value of the depth D2 from the surface of the exterior wall 220A to the boundary line BL may be substantially equal to or more than the thickness of the exterior wall 220A (for example, approximately 300 μm to approximately 400 μm).

Further, if it is difficult to cause the low resistance portions 270A and 270B to be present locally, the low resistance portions 270A and 270B may be provided in the entire end portions 216A and 216B.

The content of the electrically conductive substance with which the low resistance portions 270A and 270B are filled (the ratio of the weight of the electrically conductive substance to the total weight of the end portion 216A or 216B) is not limited in particular, but is preferably approximately 1 wt % to approximately 80 wt %, and more preferably, approximately 20 wt % to approximately 55 wt %.

Referring to FIG. 3, when the honeycomb units 230A through 230D are assembled into the honeycomb structure 200, the electrodes 260A-1 and 260B-1 provided on the honeycomb units 230A through 230D are connected (continuous) by interposing the adhesive layer 250 in end portions 215A and 215B of the honeycomb structure 200 to form electrodes 260A and 260B, respectively. Likewise, when the honeycomb structure 200 is assembled, the low resistance portions 270A and 270B provided in the honeycomb units 230A through 230D are connected (continuous) by interposing the adhesive layer in the end portions 215A and 215B, respectively, of the honeycomb structure 200.

It is clear to a person having ordinary skill in the art that the above-described effects according to the present invention are also produced by this honeycomb structure 200.

In the case where a honeycomb structure is formed of multiple honeycomb units, at least one of the honeycomb units may have a feature of the present invention. It is preferable, however, that all of the honeycomb units forming the honeycomb structure have a feature of the present invention.

If all of the honeycomb units forming the honeycomb structure have a feature of the present invention, it is possible to ensure obtaining such effects according to the present invention as described above.

### [Details of Honeycomb Structure]

Next, a description is given in more detail of a configuration of each of members of a honeycomb structure according to the embodiment of the present invention. In the following, a description is given principally of members of the honeycomb structure 200 having the structure illustrated in FIG. 3. However, it is clear to a person having ordinary skill in the art that part of the description may also be applied to the honeycomb structure 100 having the structure illustrated in FIG. 1. Further, in FIG. 3, the honeycomb units 230A through 230D have substantially the same configuration. Accordingly, the honeycomb unit 230A is taken here, and a description is given of its configuration.

### [Honeycomb Unit]

The resistance of the honeycomb unit 230A is preferably approximately 1Ω to approximately 10³Ω (except for the low resistance portions 270A and 270B). This allows the honeycomb structure 200 to be sufficiently heated even if the voltage applied across the electrodes 260A-1 and 260B-1 is, for example, approximately a voltage value of a normal battery in hybrid vehicles. If the resistance of the honeycomb unit 230A is more than or equal to approximately 1Ω, a sufficient amount of heat generation is likely to be obtained.

For example, in the case where the honeycomb unit 230A is formed of silicon carbide, it is likely to be possible to adjust the resistivity of the honeycomb unit 230A with relative ease by including a slight amount of aluminum nitride (AlN) in the base material.

If the resistance of the honeycomb unit 230A is less than or equal to approximately 10³Ω, it is less likely that electric current is less likely to flow because the resistance is not too high, so that the honeycomb unit 230A is likely to generate heat with reliability.

The above description is given of the honeycomb unit 230A (except the low resistance portions 270A and 270B, or where the electrodes 260A-1 and 260B-1 are not formed.) That is, the honeycomb unit 230A is a part that needs heat generation.

Next, a description is given below of the electrodes 260A-1 and 260B-1 of the honeycomb unit 230A.

It is desired that portions of the honeycomb unit 230A where electrodes are to be formed be free of heat generation in order to prevent degradation of the electrodes. Therefore, low resistance portions are formed in the honeycomb unit 230A.

The resistivity of the low resistance portions 270A and 270B of the honeycomb unit 230A may be any value as long as the low resistance portions 270A and 270B are lower in resistivity than other regions of the honeycomb unit 230A. For example, the resistivity of the low resistance portions 270A and 270B of the honeycomb unit 230A is preferably approximately 10⁻⁵ Ωcm to approximately 10⁻³ Ωcm.

The method of forming the low resistance portions 270A and 270B of the honeycomb unit 230A is not limited in particular. For example, the low resistance portions 270A and 270B may be formed by dipping end portions of the honeycomb unit 230A into melt containing a raw material to later form the low resistance portions 270A and 270B or slurry containing such a raw material.

The honeycomb unit 230A is formed of an inorganic material based on silicon carbide (SiC) or the like.

The cross-sectional shape of the honeycomb unit 230A perpendicular to its longitudinal directions is not limited in particular, and may be any shape such as a substantially square shape, a substantially rectangular shape, a substantially hexagonal shape, etc.

Further, the cross-sectional shape of the cells 222 of the honeycomb unit 230A perpendicular to its longitudinal directions is not limited in particular, and may be, for example, a substantially triangular shape, a substantially polygonal shape, etc., in addition to a substantially square shape.

The cell density of the honeycomb unit 230A is preferably approximately 15.5 cells/cm² to approximately 186 cells/cm² (approximately 100 cpsi to approximately 1200 cpsi), more preferably approximately 46.5 cells/cm² to approximately 170 cells/cm² (approximately 300 cpsi to approximately 1100 cpsi), and still more preferably approximately 62 cells/cm² to approximately 155 cells/cm² (approximately 400 cpsi to approximately 1000 cpsi).

The porosity of the honeycomb unit 230A is preferably approximately 35% to approximately 70%. However, the porosity is lower in the end portions 216A and 216B of the honeycomb unit 230A because of the presence of the electrically conductive substance in some pores. Therefore, the porosity in the end portions 216A and 216B of the honeycomb unit 230A is preferably 0% to approximately 20%.

The thickness of the cell walls 224 of the honeycomb unit 230A is not limited in particular. However, a desirable lower limit is preferably approximately 0.1 mm in terms of the strength of the honeycomb unit, and a desirable upper limit is preferably approximately 0.4 mm in terms of the conversion performance of the honeycomb structure.

The catalyst supported on the cell walls 224 of the honeycomb unit 230A is not limited in particular, and, for example, platinum, rhodium, palladium, etc., may be used. The catalyst may be supported on the cell walls 224 by interposing an aluminum layer.

### [Adhesive Layer]

The adhesive layer 250 of the honeycomb structure 200 is formed using adhesive layer paste as its raw material. The adhesive layer paste may contain inorganic particles, an inorganic binder, inorganic fibers, and/or an organic binder.

Silicon carbide (SiC) is desirable as inorganic particles of the adhesive layer paste. Inorganic sol, a clay-based binder, etc., may be used as the inorganic binder. Examples of the inorganic sol include alumina sol, silica sol, titania sol, water glass and the like. Examples of the clay-based binder include clay, kaolin, montmonrillonite, sepiolite, attapulgite, and the like. These may be used alone or in combination.

Of these, alumina sol, silica sol, titania sol, water glass, sepiolite, or attapulgite is desirable.

Alumina, silica, silicon carbide, silica-alumina, glass, potassium titanate, aluminum borate or the like is desirable as the material of the inorganic fibers. These may be used alone or in combination. Of the above-described materials, silica-alumina is desirable.

The organic binder is not limited in particular, and is, for example, one or more selected from polyvinyl alcohol, methylcellulose, ethylcellulose, carboxymethylcellulose, etc. Of the organic binders, carboxymethylcellulose is desirable.

The thickness of the adhesive layer 250 is preferably approximately 0.3 mm to approximately 2 mm. This is because if the thickness of the adhesive layer 250 is more than or equal to approximately 0.3 mm, sufficient joining strength of the honeycomb units is likely to be obtained. If the thickness of the adhesive layer 250 is less than or equal to approximately 2 mm, the pressure loss of the honeycomb structure is less likely to increase. The number of honeycomb units to be joined is suitably selected in accordance with the size of the honeycomb structure.

### [Honeycomb Structure]

A honeycomb structure according to the embodiment of the present invention may have any shape. For example, in addition to a substantial circular-pillar shape illustrated in FIG. 1 and FIG. 3, the honeycomb structure may also have a substantial cylindroid shape, a substantial square pillar shape, a substantial polygonal pillar shape, etc.

In the cases illustrated in FIG. 1 and FIG. 3, the electrodes 160A and 160B and the electrodes 260A and 260B are provided on the end portions 115A and 115B of the honeycomb structure 100 and the end portions 216A and 216B of the honeycomb structure 200, respectively. However, the positions where electrodes are provided are not limited to these, and the electrodes may be provided at any locations on the outer peripheral surface of the honeycomb structure.

### [Method of Manufacturing Honeycomb Structure]

Next, a description is given briefly of a method of manufacturing a honeycomb structure according to the embodiment of the present invention.

### [Manufacture of Honeycomb Unit]

First, honeycomb unit molded bodies are made by extrusion molding or the like using raw material paste having inorganic particles including silicon carbide (SiC) and an inorganic binder as principal components, and further having inorganic fibers added as required. A suitable amount of aluminum nitride (AlN) or the like may be further added to the raw material paste in order to adjust the resistivity of the honeycomb unit.

In addition to these, an organic binder, a dispersion medium, and a molding aid may be suitably added to the raw material paste in accordance with moldability. The organic binder is not limited in particular. The organic binder includes one or more organic binders selected from, for example, methylcellulose, carboxymethylcellulose, hydroxyethylcellulose, polyethylene glycol, phenolic resin, epoxy resin, etc. The amount of the organic binder blended is preferably approximately 1 to approximately 10 parts by weight to the total of 100 parts by weight of the inorganic particles, inorganic binder, and inorganic fibers.

The dispersion medium is not limited in particular, and may be, for example, water, an organic solvent (such as benzene), alcohol (such as methanol), etc. The molding aid is not limited in particular, and may be, for example, ethylene glycol, dextrin, a fatty acid, fatty acid soap, polyalcohol, etc.

The raw material paste is not limited in particular, and is preferably subjected to mixing and kneading. For example, the raw material paste may be mixed using a mixer, attritor or the like, and may be well kneaded with a kneader or the like. The method of molding the raw material paste is not limited in particular. It is preferable, for example, to form the raw material paste into a shape having cells by extrusion molding or the like.

Next, it is preferable to dry the obtained molded bodies. The drying apparatus used for drying is not limited in particular, and may be a microwave drying apparatus, a hot air drying apparatus, a dielectric drying apparatus, a reduced-pressure drying apparatus, a vacuum drying apparatus, a freeze drying apparatus, etc. Further, it is preferable to degrease the obtained dried molded bodies. The conditions for degreasing, which are not limited in particular and are suitably selected in accordance with the kind and amount of the organic matter included in the molded bodies, are preferably approximately 400° C. and approximately two hours. Further, it is preferable to subject the obtained molded bodies to firing. The condition for firing, which is not limited in particular, is preferably approximately 2700° C.

### [Formation of Low Resistance Portions]

Next, low resistance portions are formed one on each end portion of each honeycomb unit. As described above, the low resistance portions may be formed by dipping the honeycomb unit into melt containing a raw material to later form the low resistance portions or slurry containing such a raw material. The honeycomb unit after dipping is subjected to heat treatment, so that an electrically conductive substance such as metal and/or a silicide compound, is fixed in pores of the honeycomb unit.

For example, in the case of selecting silicon as an electrically conductive substance to fill in the low resistance portions, slurry containing silicon particles, an organic binder, and water is prepared. Further, after dipping the end portions of the honeycomb unit into this slurry, the honeycomb unit is subjected to heat treatment at approximately 1500° C. for approximately one hour in an Ar atmosphere. Thereby, pores of the honeycomb unit are filled with silicon throughout the end portions of the honeycomb unit, so that the low resistance portions may be formed.

Further, in the case of selecting nickel silicide as an electrically conductive substance to fill in the low resistance portions, slurry containing silicon particles, nickel particles, an organic binder, and water is prepared. Next, after dipping the end portions of the honeycomb unit into this slurry, the honeycomb unit is subjected to heat treatment at approximately 900° C. for approximately one hour in a nitrogen atmosphere. Thereby, the pores of the honeycomb unit are filled with nickel silicide throughout the end portions of the honeycomb unit, so that the low resistance portions may be formed.

### [Assembly of Honeycomb Structure]

Thereafter, a catalyst is supported on the cell walls of each honeycomb unit.

Next, adhesive layer paste to later become an adhesive layer is applied on a side of a honeycomb unit obtained in the above-described process to be substantially uniform in thickness, and thereafter, another honeycomb unit is successively stacked on the honeycomb unit by interposing this adhesive layer paste. This process is repeated so that a honeycomb structure of a desired size is manufactured.

Next, this honeycomb structure is heated to dry and solidify the adhesive layer paste, thereby forming an adhesive layer and fixing the honeycomb units to each other.

It is preferable to degrease this honeycomb structure after joining the multiple honeycomb units with the adhesive layer. As a result of this treatment, if an organic binder is included in the adhesive layer paste, this organic binder can be removed by degreasing. The conditions for degreasing, which are suitably determined in accordance with the kind and amount of the included organic material, are preferably approximately 700° C. and approximately two hours.

Next, annular electrode terminals are provided, one at each end portion of the honeycomb structure, so as to be in contact with the low resistance portions of the honeycomb units.

A honeycomb structure may be manufactured by the above-described process.

Obviously, numerous modifications and variations of the present invention are possible in light of the above teachings. It is therefore to be understood that within the scope of the appended claims, the invention may be practiced otherwise than as specifically described herein.

What is claimed is:

1. A honeycomb structure comprising:
at least one honeycomb unit comprising:
a pair of electrodes; and
cell walls extending along a longitudinal direction of the at least one honeycomb unit to define a plurality of through holes, the cell walls having pores filled with a substance under a formation region of the pair of electrodes, the substance having an electrical resistivity lower than an electrical resistivity of a material to form the at least one honeycomb unit.

2. The honeycomb structure as claimed in claim 1, wherein the substance includes at least one of metal and a silicide.

3. The honeycomb structure as claimed in claim 2, wherein the metal comprises one of silicon and nickel.

4. The honeycomb structure as claimed in claim 3, wherein the metal is the silicon.

5. The honeycomb structure as claimed in claim 2, wherein the silicide comprises one of nickel silicide, chromium silicide, and iron silicide.

6. The honeycomb structure as claimed in claim 5, wherein the silicide is the nickel silicide.

7. The honeycomb structure as claimed in claim 1, wherein the pair of electrodes are formed to surround peripheries of cross sections perpendicular to the longitudinal direction of the at least one honeycomb unit.

8. The honeycomb structure as claimed in claim 1, wherein
the at least one honeycomb unit includes
an outer peripheral wall defining an outer periphery of the at least one honeycomb unit and
an interior wall separating the plurality of through holes of the at least one honeycomb unit,
the pair of electrodes are formed on an outer peripheral surface of the outer peripheral wall,
the interior wall is electrically connected to the outer peripheral wall having the pair of electrodes formed thereon, and
the pores in the interior wall are filled with the substance having the electrical resistivity lower than the electrical resistivity of the material to form the at least one honeycomb unit.

9. The honeycomb structure as claimed in claim 8, wherein a region where at least one of the outer peripheral wall and the interior wall of the at least one honeycomb unit is filled with the substance having the electrical resistivity lower than the electrical resistivity of the material to form the at least one honeycomb unit is wider than the pair of electrodes in the longitudinal direction.

10. The honeycomb structure as claimed in claim 1, wherein a resistance between the pair of electrodes is approximately 1Ω to approximately 10³Ω in the at least one honeycomb unit.

11. The honeycomb structure as claimed in claim 1, wherein the honeycomb structure is formed of a plurality of honeycomb units bonded by interposing an adhesive layer.

12. The honeycomb structure as claimed in claim 1, wherein the pair of electrodes are formed by one of spraying and sputtering.

13. The honeycomb structure as claimed in claim 1, wherein a catalyst is supported on the cell walls of the at least one honeycomb unit.

14. The honeycomb structure as claimed in claim 13, wherein the catalyst comprises one of platinum, rhodium, and palladium, and the catalyst is supported on the cell walls by interposing an aluminum layer.

15. The honeycomb structure as claimed in claim 1, wherein the at least one honeycomb unit includes silicon carbide as a principal component.

16. The honeycomb structure as claimed in claim 1, wherein a resistance adjusting component is added to the at least one honeycomb unit.

17. The honeycomb structure as claimed in claim 16, wherein the resistance adjusting component comprises aluminum nitride.

18. The honeycomb structure as claimed in claim 1, wherein the pair of electrodes comprise a metal.

19. The honeycomb structure as claimed in claim 1, wherein a first portion of the at least one honeycomb unit filled with the substance having the electrical resistivity lower than the electrical resistivity of the material to form the at least one honeycomb unit is lower in resistivity than a second portion of the at least one honeycomb unit other than the first portion.

20. The honeycomb structure as claimed in claim 19, wherein the first portion of the at least one honeycomb unit filled with the substance having the electrical resistivity lower than the electrical resistivity of the material to form the at least one honeycomb unit has a resistivity of approximately 10⁻⁵ ωcm to approximately 10⁻³ Ωcm.

21. The honeycomb structure as claimed in claim 1, wherein a first portion of the at least one honeycomb unit filled with the substance having the electrical resistivity lower than the electrical resistivity of the material to form the at least one honeycomb unit is approximately 30 μm to approximately 100 μm deep from an outer peripheral surface of an outer peripheral wall of the at least one honeycomb unit defining an outer periphery thereof.

22. The honeycomb structure as claimed in claim 1, wherein the at least one honeycomb unit is filled with the substance having the electrical resistivity lower than the electrical resistivity of the material to form the at least one honeycomb unit substantially throughout end portions of the at least one honeycomb unit in the longitudinal direction.

23. The honeycomb structure as claimed in claim 22, wherein a filling amount of the substance having the electrical resistivity lower than the electrical resistivity of the material to form the at least one honeycomb unit is approximately 1 wt % to approximately 80 wt % of a total weight of the end portions of the at least one honeycomb unit.

24. The honeycomb structure as claimed in claim 1, wherein the at least one honeycomb unit has a porosity of 0% to approximately 20% in a portion thereof filled with the substance having the electrical resistivity lower than the electrical resistivity of the material to form the at least one honeycomb unit.

25. The honeycomb structure as claimed in claim 1, wherein the honeycomb structure comprises four of the at least one honeycomb unit.

26. The honeycomb structure as claimed in claim 1, wherein
the at least one honeycomb unit has a plurality of honeycomb units, and
each of the plurality of honeycomb units has a pillar structure having a plurality of end faces having a substantially sectorial shape of a substantially quarter circle, a plurality of sides having a substantially flat surface, and a side having a curved surface.

27. The honeycomb structure as claimed in claim 1, wherein a porosity of the at least one honeycomb unit is 0% to approximately 20% in end portions thereof in the longitudinal direction, and the porosity of the at least one honeycomb unit is approximately 35% to approximately 70% except for the end portions.

28. The honeycomb structure as claimed in claim 1, further comprising:
a plurality of annular electrode terminals provided at each of end portions of the honeycomb structure in the longitudinal direction so as to be in contact with a portion of the at least one honeycomb unit filled with the substance having the electrical resistivity lower than the electrical resistivity of the material to form the at least one honeycomb unit.
